(19) United States
(12) Patent Application Publication
(10) Pub. No.: US 2014/0348290 A1
(43) Pub. Date: Nov. 27, 2014

(54) Apparatus and Method for Low Capacitance Packaging for Direct Conversion X-Ray or Gamma Ray Detector

(71) Applicant: General Electric Company, Schenectady, NY (US)

(72) Inventors: Daniel David Harrison, Delanson, NY (US); James Rose, Niskayuna, NY (US); Abdelaziz Ikhlef, Waukesha, WI (US); Vladimir Lobastov, Niskayuna, NY (US)

(73) Assignee: General Electric Company, Schenectady, NY (US)

(21) Appl. No.: 13/901,198

(22) Filed: May 23, 2013

(51) Int. Cl. G01T 1/16; G01N 23/04

(52) U.S. Cl. CPC G01T 1/16; G01N 23/046
USPC 378/19; 250/394

(57) ABSTRACT

A direct-conversion X-ray detector includes one or more detector modules. The detector modules can include a substrate, one or more sensor tiles, and one or more photon-counting application specific integrated circuit (ASIC). The substrate has a dielectric constant of less than about 3.5 and is capable of lithographic conductor patterning with feature sizes of about 5 um or less. The one or more X-ray direct conversion sensor tiles have an array of one or more electrodes electrically coupled to a first surface of the substrate. The one or more ASICs are electrically coupled to the substrate and disposed laterally along the substrate with respect to the one or more direct conversion sensor tiles. Conductive lines are spaced along the substrate and are configured to electrically couple the one or more X-ray direct conversion sensor tiles to the one or more ASICs.

### BACKGROUND

Exemplary embodiments of the present disclosure generally relate to an X-ray detector, and more particularly, to a low capacitance packaging for direct conversion X-ray or gamma ray detector modules that can be used as a modular tileable elements in a large area detector such as in a computed tomography (CT) system.

Radiographic imaging systems, such as X-ray and computed tomography (CT), have been employed for observing interior aspects of an object. Typically, the imaging systems include an X-ray source that is configured to emit X-rays toward an object of interest, such as a patient. A detecting device, such as an array of radiation detectors, is positioned on the other side of the object and is configured to detect the X-rays transmitted through the object of interest.

One known detector used in a computed tomography (CT) system includes an energy discriminating, direct conversion detector. When subjected to X-ray energy, a sensor element in the detector converts the detected X-ray energy to an analog electrical signal corresponding to the incident X-ray flux.

As part of the data acquisition system (DAS), an Application Specific Integrated Circuit (ASIC) may acquire the analog signals from the detector and convert these signals to digital signals for subsequent processing. Conventional detector module packaging includes the detector and ASIC with a module layout that supports only one detector orientation relative to the incident X-rays. Typically, X-ray detectors are stacked in vertical alignment with a corresponding ASIC due to the need for high density, low capacitance electrical connections between the detector and ASIC. Low capacitance connections are needed to maintain signal integrity with the rapid transient (typically 40 ns or less) analog electrical signals.

Vertical stacking of an ASIC with a x-ray detector can present some problematic conditions. For example, heat generated by the ASIC can couple to the detector and introduce unwanted noise and thermal variation. Further, vertical stacking hampers the ability to detect radiation with anode side illumination, due to the ASIC being disadvantageously irradiated by the incident X-rays.

Accordingly, it is desirable to provide a detector module layout and system of interconnects that provide a high density, low capacitance signal path between a direct conversion sensor and an ASIC while permitting the ASIC to be offset laterally from the sensor.

### SUMMARY

In exemplary embodiments, a direct-conversion X-ray detector can include one or more detector modules. Each detector module can include a substrate, one or more X-ray direct conversion sensor tiles, and one or more photon-counting application specific integrated circuits (ASICs). The substrate has a dielectric constant of less than about 3.5 and is capable of lithographic conductor patterning with feature sizes of about 5 um or less. At least one X-ray direct conversion sensor tile has an array of one or more electrodes that can be electrically coupled to a first surface of the substrate. The photon-counting ASIC(s) can have a peaking time of 160 nanoseconds or less. The one or more ASICs are electrically coupled to the substrate and disposed laterally along the substrate with respect to the one or more direct conversion sensor tiles. Conductive lines are spaced along the substrate, wherein the conductive lines are configured to electrically couple the one or more X-ray direct conversion sensor tiles to the one or more ASICs.

In some embodiments, the ratio of spacing to width of the plurality of conductive lines can be greater than 3:1, the width of each of the plurality of conductive lines is less than 5 microns, and/or the spacing between each of the plurality of conductive lines is less than 25 microns.

In some embodiments, the ASIC can be disposed within the substrate.

In some embodiments, at least one fusible link can be disposed along at least one of the plurality of conductive lines. The at least one fusible link can be configured and adapted to provide electrostatic discharge protection.

In some embodiments, the one or more direct conversion sensor tiles and the one or more ASICs can be disposed along the first surface of the substrate. In some embodiments, the one or more direct conversion sensor tiles can be arranged to detect an energy ray that impinges through a second surface of the substrate. In some embodiments, the one or more direct conversion sensor tiles can be arranged to detect an energy ray that impinges upon the sensor tile without passing through the substrate.

In some embodiments, the substrate can be formed of glass, fused quartz, and/or sapphire.

In some embodiments, a second substrate can include a first and a second surface, wherein each of the first and second surfaces includes electrical contact pads. The contact pads disposed on the first surface can be arranged to match electrical contact pads of each ASIC. The contact pads disposed on the second surface can be arranged to match the termini of the conductive lines on the first substrate. The second substrate can provide electrical connection between the contact pads on the second surface and the contact pads on the first surface using through-vias. The second substrate can be placed between the first substrate and the one or more ASICs. The pads on the second surface of the second substrate can be conductively attached to the termini of the conductive lines on the first substrate. The contact pads of the one or more ASICs can be conductively attached to the first surface of the second substrate. In some embodiments, the second substrate provides additional electrical connections to enable distribution of power, control, and data signals between the one or more ASICs and an external system. In some embodiments, the second substrate is a flexible dielectric film, such as polyimide.

In another embodiments, an imaging system is disclosed that includes an imaging source and a detector. The detector can include one or more detector modules, each of which can include a substrate, at least one direct conversion sensor tile, and at least one photon-counting Application Specific Integrated Circuit (ASIC). The substrate has a dielectric constant of less than about 3.5 and is capable of lithographic conductor patterning with feature sizes of about 5 um or less. The at least one direct conversion sensor tile can be electrically coupled to a first surface of the substrate. The at least one ASIC has a peaking time of 160 nanoseconds or less and is electrically coupled to the substrate. The ASIC is disposed laterally along the substrate with respect to the at least one direct conversion sensor tile. Conductive lines are spaced along the substrate and are configured to electrically couple the at least one direct conversion sensor tile to the at least one ASIC.

In some embodiments, the detector modules can be disposed laterally along a common plane. In some embodiments, the detector modules can be disposed in an offset and/or overlapping configuration. In some embodiments, adjacent sensor tiles on each of the detector modules abut and there is a fixed angular offset between the planes of adjacent detector modules. In some embodiments, the detector modules can be arranged such that substantially no part of each of the at least one direct conversion sensor tiles are blocked from detecting an energy ray from the illumination source by adjacent detector modules.

In some embodiments, the at least one direct conversion sensor tile associated with each of the detector modules can be arranged to detect an energy ray that impinges through a second surface of the substrate with substantially no part of any of the at least one direct conversion sensor tile being blocked by adjacent detector modules.

Any combination or permutation of embodiments is envisioned. Additional advantageous features, functions and applications of the disclosed systems, assemblies and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

FIG. 1 is a perspective view of a computed tomography (CT) imaging system according to one embodiment of the present invention;

FIG. 2 is a schematic view of the CT imaging system of FIG. 1;

FIG. 3 is a side view of a detector module according to an exemplary embodiment of the present disclosure, showing a plurality of direct conversion sensors mated directly to a substrate;

FIG. 4 is a side view of a detector module according to an exemplary embodiment of the present disclosure, showing a direct conversion sensor mated to a ceramic interposer which is connected to a substrate;

FIGS. 5A-5C are side views of detector modules according to an exemplary embodiment of the present disclosure, showing module layering arrangements for wide X-ray detection;

FIGS. 6A-6B are side views of detector modules according to an exemplary embodiment of the present disclosure, showing module shingle arrangements for wide X-ray detection;

FIGS. 7A-7B are side views of a detector module according to exemplary embodiments of the present disclosure, showing a plurality of direct conversion sensors arranged in a two-dimensional tiled configuration;

FIGS. 8A-8B are side and front views, respectively, of a detector module according to an exemplary embodiment of the present disclosure, showing a multiple module support structure and layout for wide X-ray detection; and

FIGS. 9A-9B are side views of a detector module according to an exemplary embodiment of the present disclosure, showing a connection of a module to a DAS assembly.

### DETAILED DESCRIPTION

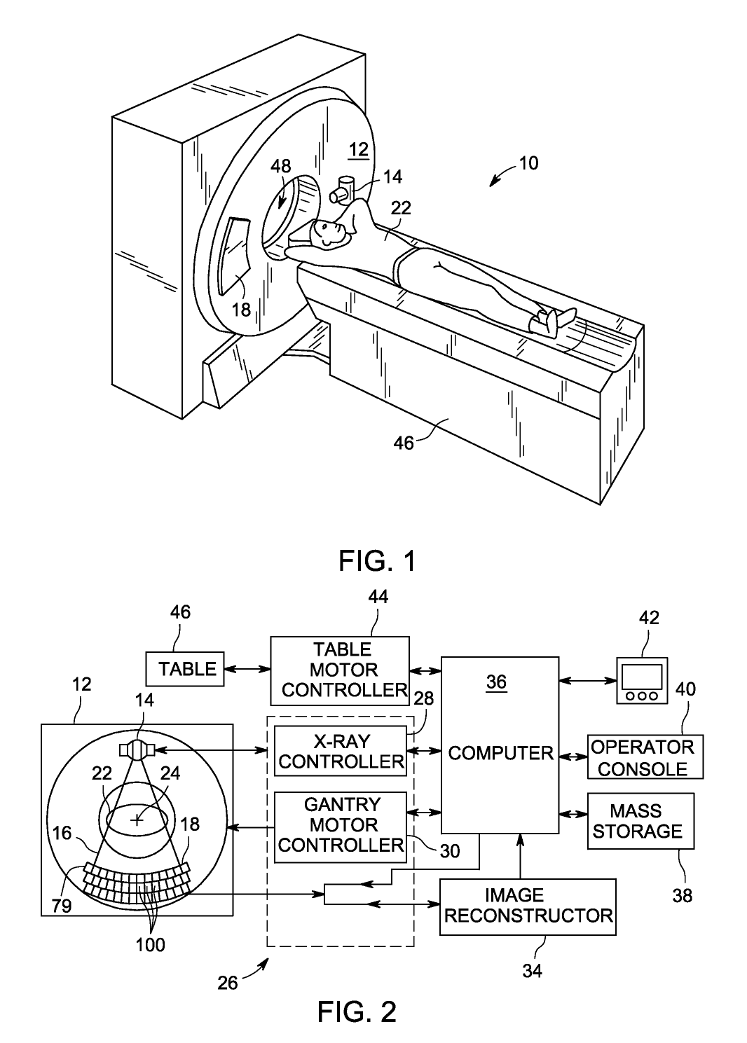

Referring to FIGS. 1 and 2, an embodiment of a computed tomography (CT) imaging system 10 is shown as including a gantry 12 representative of a CT scanner. Gantry 12 has an X-ray source 14 that projects a beam of X-rays 16 toward a detector assembly 18 on the opposite side of the gantry 12. Detector assembly 18 is formed by a plurality of detector modules 100 which together sense the projected X-rays that pass through a medical patient 22. Each detector module 100 includes an array of sensor pixels with each pixel producing an electrical signal that represents the arrival rate and energy distribution of the impinging X-ray photons. Each detector module 100 also includes one or more application specific integrated circuits (ASIC) that process and digitize the sensor signals. The resulting digital projection data indicate the energy dependent X-ray attenuation of the patient along the ray paths from X-ray source 14 to each sensor pixel. The data are sent from detector assembly 18 to image reconstructor 34 where the attenuation information is used to reconstruct cross-sectional material density images. During a scan to acquire X-ray projection data, gantry 12 and the components mounted thereon rotate about a center of rotation 24. Rotation of gantry 12 and the operation of X-ray source 14 are governed by control system 26 of CT system 10. Control system 26 includes an X-ray controller 28 that provides power and timing signals to X-ray source 14 and gantry motor controller 30 that controls the rotational speed and position of gantry 12. The reconstructed image is applied as an input to computer 36 which stores the image in mass storage device 38.

Computer 36 also receives commands and scanning parameters from an operator via console 40 configured to allow an operator to interact with the computer 36. For example, the console 40 can include a keyboard, touchscreen, mouse, joystick, and the like An associated display 42 allows the operator to observe the reconstructed image and other data from computer 36. The operator supplied commands and parameters are used by computer 36 to provide control signals and information to the detector ASICs, X-ray controller 28 and gantry motor controller 30. In addition, computer 36 operates table motor controller 44 which controls motorized table 46 to position patient 22 in gantry 12. Particularly, table 46 moves portions of patient 22 through gantry opening 48.

While exemplary embodiments of the detector modules are described relative to a CT system, those skilled in the art will recognize that the detector modules can be utilized in other systems for detecting radiation. For example, in some embodiments, the detector modules can be used in X-ray scanners for luggage inspection, in gamma ray detectors, or as an X-ray detector for crystallography.

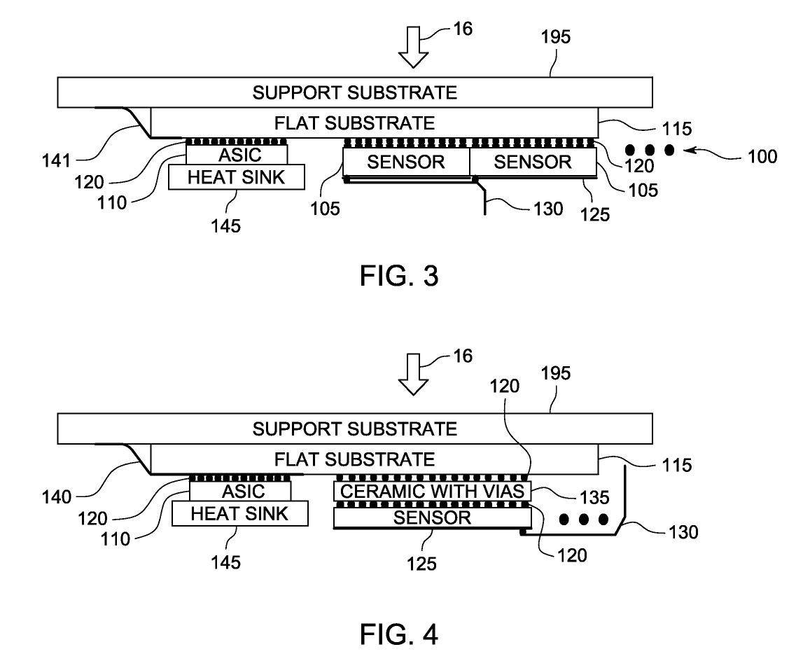

As shown in FIG. 3, according to an exemplary embodiment of one of the detector module 100, direct conversion sensor tiles 105 (hereinafter sensors 105) are attached to substrate 115, such as glass, fused quartz and/or sapphire, which has a dielectric constant of less than about 3.5 and is capable of lithographic conductor patterning with feature sizes of about Sum or less. The dielectric constant and patterning capability of the substrate 115 can advantageously facilitate formation of the detector module 100 to accommodate the closely (densely) spaced conductive lines being routed from the sensors 105 to the ASIC 110, while providing comparable and/or improved performance compared to conventional detector modules. In some embodiments, support structure 195 can be provided for further structural support of substrate 115. In some embodiments, the detector module 100 can be devoid of the support structure 195.

ASIC 110 is connected to substrate 115 laterally offset from direct conversion sensors 105. The lateral offset between ASIC 110 and direct conversion sensors 105 allows for heat generated by ASIC 110 to be dissipated away from direct conversion sensors 105 to reduce sensor thermal variations and to allow for lower-noise and faster operation of ASIC 110 compared to conventional detector structures. Furthermore, disposing the ASIC 110 laterally offset from the sensors 105, advantageously allows exemplary embodiments of the detector modules 100 of the present disclosure to receive X-rays from either side of the sensor (i.e., to implement Anode or Cathode sensor illumination). ASIC 110 can be a photon-counting ASIC having a peaking time of 160 nanoseconds or less, which corresponds to a response time of an electronic amplification channel of the ASIC 110 to a time-narrow pulse of current from an X-ray detector pixel of one of the sensors 105.

Conductive lines on substrate 115 connect ASIC electrical inputs and outputs to the sensors 105 and to input-output connection 141. The conductive lines connecting the sensors 105 to the ASIC 110 may have to be very dense while having low mutual and absolute capacitance. This may require the conductive lines disposed with respect to the substrate 115 to have a ratio of line spacing to line width of greater than approximately 3:1. In one embodiment, the width of each sensor conductive line on substrate 115 is approximately 5 microns and the spacing between each of the conductive lines is approximately 25 microns. Fusible links can be incorporated with conductive lines to provide for ASIC electrostatic discharge (ESD) protection during the manufacturing process. High voltage interconnect 130 makes contact with sensor cathode 125 to provide necessary sensor bias. In one embodiment, the ASIC 110 can be constructed within substrate 115 using traditional lithographic techniques. Since the substrate 115 can be formed from a material that does not inhibit X-ray propagation and the ASIC 110 is laterally offset from the sensors 105, the detector module 100 advantageously supports X-ray illumination from either the substrate side of sensors 105, or the opposing (e.g., cathode) side of the sensors 105. With substrate-side illumination, the X-ray absorption of the substrate and electrical contacts must be accounted. In some embodiments, one orientation may be preferable to the other.

In some embodiments, the ASIC 110 can be directly coupled to the substrate 115. The sensor(s) 105 can include a large quantity of sensor outputs (e.g., 64 or more individual channels) that are routed to the (one or more) ASIC 110. The ASIC 110 and the substrate can have corresponding electrical contacts to electrically couple the ASIC 110 to the sensor outputs via the conductive lines. The ASIC 110 can be directly coupled using, for example, an electrical conductive epoxy, pressure sensitive adhesive, or a sufficiently low-temperature solder. In some embodiments, a low-temperature solder may require that specific metal types be available as a surface finish for the substrate contacts.

In some embodiments, the sensor signal lines and the ASIC power lines can have conflicting requirements. For example, the many sensor signal lines may have to be narrow and dense for low capacitance while the ASIC power lines must be wide and/or thick for low resistance and inductance. Referring now to FIG. 4, interposer layer 140 (e.g. flexible dielectric film, such as polyimide) is shown disposed between ASIC 110 and substrate 115. Interposer layer 140 can have interconnect vias 120 extending from electrical contacts on an ASIC-facing surface of the interposer layer 140 to electrical contacts on an opposing substrate-facing surface of the interposer layer 140. In an exemplary embodiment, the vias electrically connect sensor signals on substrate 115 to ASIC 110 through the interposer layer 140. Interposer layer 140 can have electrical contacts on the ASIC-facing surface with a layout that corresponds to the layout of the electrical contacts of the ASIC and have electrical contacts on the substrate-facing surface that corresponds to the layout of the electrical contacts on the substrate.

By placing interposer layer 140 between ASIC 110 and substrate 115, further improvements can be realized. For example, the layout of the electrical contacts on the ASIC can be different than the layout of the electrical contacts of the substrate. By allowing the layouts of the electrical contacts to be different, the density of the layout of the electrical contacts of the ASIC and/or the substrate can be less dense and/or can have a footprint that is larger than or smaller than the perimeter of the ASIC. Interposer layer 140 can be sufficiently flexible to provide protection for ASIC 110 from thermal stress due to CTE mismatch between the ASIC and substrate 115 during assembly and operation of module 100. Also, interposer layer 140 can provide additional electrical connections for power, control, and data signals between ASIC 110 and an external system. These interposer connections may have lines that are thicker or wider than are practical on substrate 115. Using this approach, in some embodiments, conductive lines from the sensors 105 can be routed to the ASIC from one side of interposer 140, and conductive lines for the power, control, and data signals can be routed to the ASIC from an opposite side of the interposer. Further, direct conversion sensor 105 is shown attached to ceramic interposer 135 for both CTE mismatch protection as well as to allow ease of handling and testing before final assembly with substrate 115. In one embodiment, direct conversion sensor 105 is attached to ceramic interposer 135 with low-temperature epoxy to avoid high-temperature damage during further assembly of module 100.

In exemplary embodiments, the ASIC 110 can be implemented as a chip scale package (CSP). The package can be connected to a heat sink to promote heat dissipation and can include an integral FR4 interposer to provide for a ball-grid array as electrical connection to ASIC 110. The CSP can include an integral Cu/Mo slug connected to ASIC 110 to provide a heat transfer conduit to the heat sink.

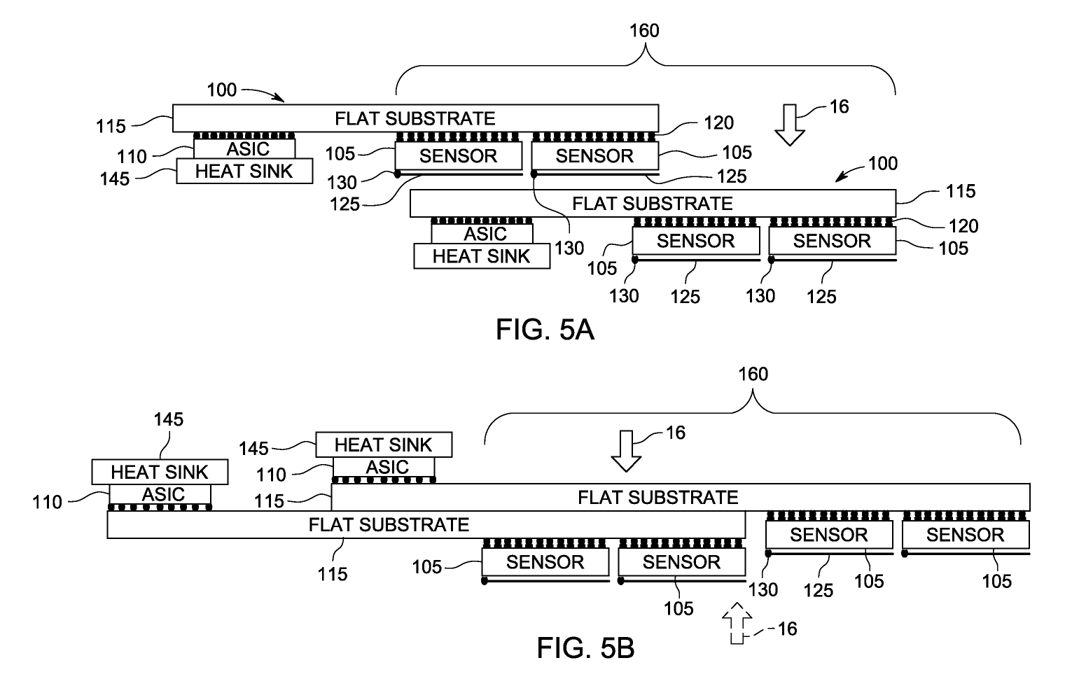

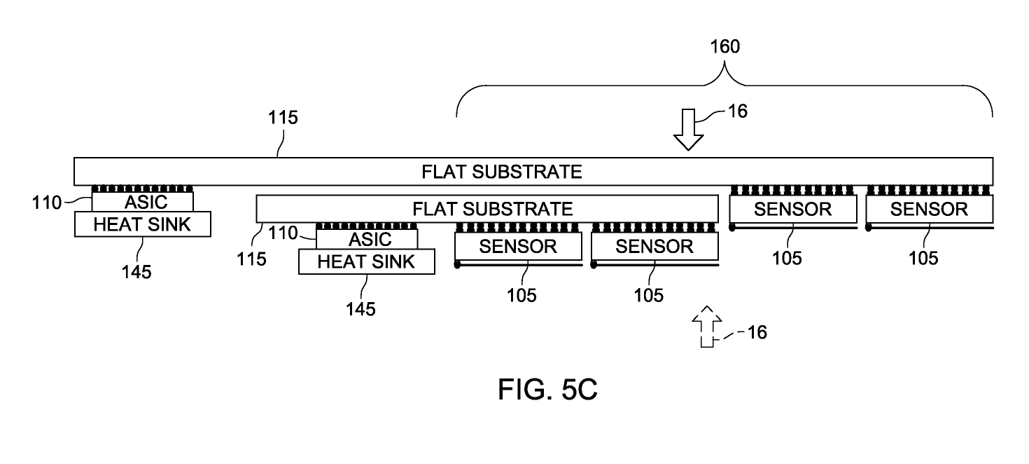

With reference to FIGS. 5A-5C, exemplary embodiments of the modules 100 are shown in different layered and/or overlapping configurations for enabling wide X-ray detection area 160. By providing lateral spacing of ASIC 110 from corresponding direct conversion sensors 105, each ASIC 110 can be shielded from X-ray illumination while allowing anode side X-ray illumination of direct conversion sensors 105 and providing wide X-ray detection area 160. ASIC 110 can be connected directly to substrate 115 or connected to interposer 140 as shown in FIGS. 3 and 4.

As shown in FIG. 5A, the sensors 105 and ASIC 110 on each of the modules 100 can be operatively coupled to the same surface of the substrate 115 such that the sensors 105 and the ASIC 110 are laterally offset from each other and reside substantially in the same plane. In the present embodiment, the modules 100 can have a staggered overlapping layered arrangement so that the sensors have a laterally adjacent configuration to form the detector area 160. X-rays from an X-ray source can impinge on the substrate-facing side of the sensors 105 (through the substrate). The “shingled” configuration facilitates shielding the ASIC 110 of one of the modules 100 by the sensors 105 of another one of the modules, facilitates lateral proximity of sensors 105 from different modules 100, and promotes isolation of the thermal effects of the ASICs 110 from the sensors 105. In some embodiments, each detector module 100 in FIG. 5A can be inverted in place so that each sensor directly faces the X-ray illumination 16.

FIG. 5B shows another arrangement of another exemplary embodiment of the modules 100. The sensors 105 and ASIC 110 on each of the modules 100 can be operatively coupled to opposing surfaces of the substrate 115 such that the sensors 105 and the ASIC 110 of each modules 100 are laterally offset from each other and reside in different planes. In the present embodiment, the modules 100 can have a staggered overlapping layered arrangement so that the sensors have a laterally adjacent configuration to form the detector area 160. In this embodiment, X-rays from an X-ray source can be configured to impinge on the substrate-facing side of the sensors 105 and/or the surface of the sensors facing away from the substrate 115. This embodiment requires a method (e.g., through-silicon vias) to conduct sensor signals from the sensor side of substrate 115 to the ASIC side of the substrate.

FIG. 5C shows another arrangement of another exemplary embodiment of the modules 100 that is similar to the embodiment shown in FIG. 5A in that a method of conducting sensor signals between opposing sides of substrate 115 is not required. In this embodiment with a staggered overlapping layered arrangement of the modules, one of the modules 100 can have a length that is greater that the length of another one of the modules 100 and can have a space between the ASIC and the sensors to receive a portion of the other module 100 such the substrates 115 of the modules are adjacently disposed with respect to each other and so that the other module 100 is bounded between sensors 105 and the ASIC 110 of the longer module 100. This embodiment can also be beneficially thinner than the embodiments of FIG. 5A or FIG. 5B. As with the embodiment of FIG. 5B, detector module 100 may be illuminated with X-rays from either the substrate side of each sensor, or from the opposing side.

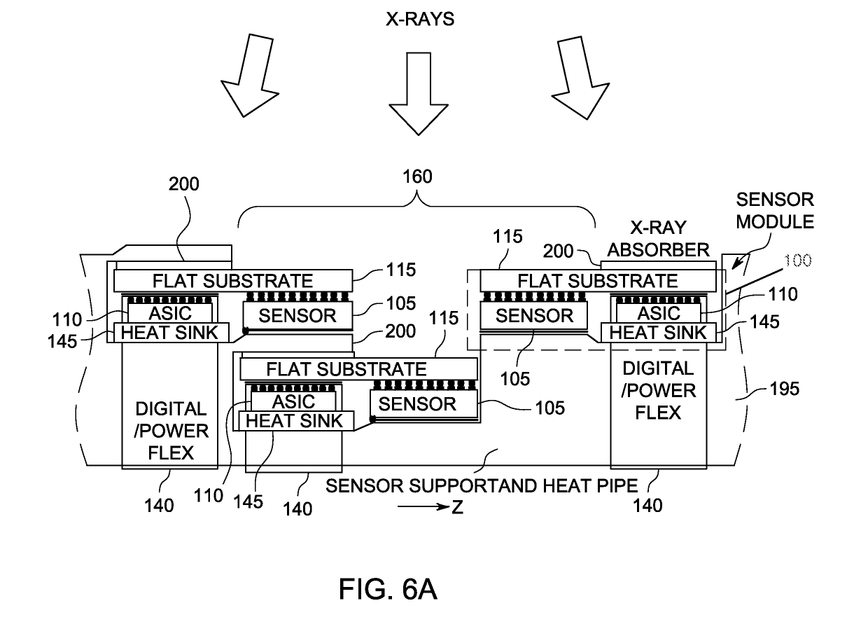

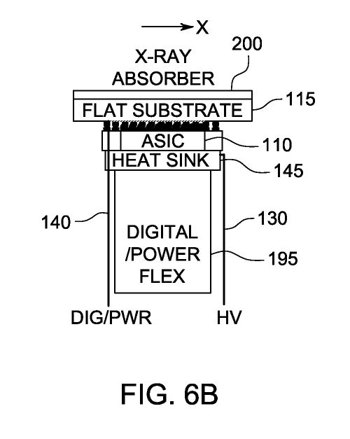

FIGS. 6A-6B show an exemplary embodiment of a layered module 100 configuration for wide X-ray detection area 160. This arrangement uses a module architecture substantially as in FIG. 5A. Modules 100 may each use one or more sensors 105 and ASICs 110. The embodiment includes both overlapping and non-overlapping modules while support structure 195 holds each module 100 in place. The use of one non-overlapping module provides a reversal of the overlap direction and allows the modules to maintain a substantially similar distance from the X-ray source. Alternatively, all modules may use a single overlap direction. With the present embodiment, a wider detection range 160 can be achieved by adding more similarly oriented modules to the left and right ends of sensor support 195. The modules 100 can be positioned such that the modules reside in parallel planes. Alternatively, the module planes may be advantageously tilted with respect to one another so that all sensors 105 are substantially perpendicular to X-rays arriving from a common X-ray point source. Support structure 195 can also allow for improved heat transfer from heat sink 145 and X-ray absorber 200 protects ASIC 110 from X-ray illumination and damage. While this embodiment illustrates X-ray illumination of each sensor 105 from the substrate side, each detector module 100 may be advantageously inverted in place to allow illumination of the opposite side of each sensor 105.

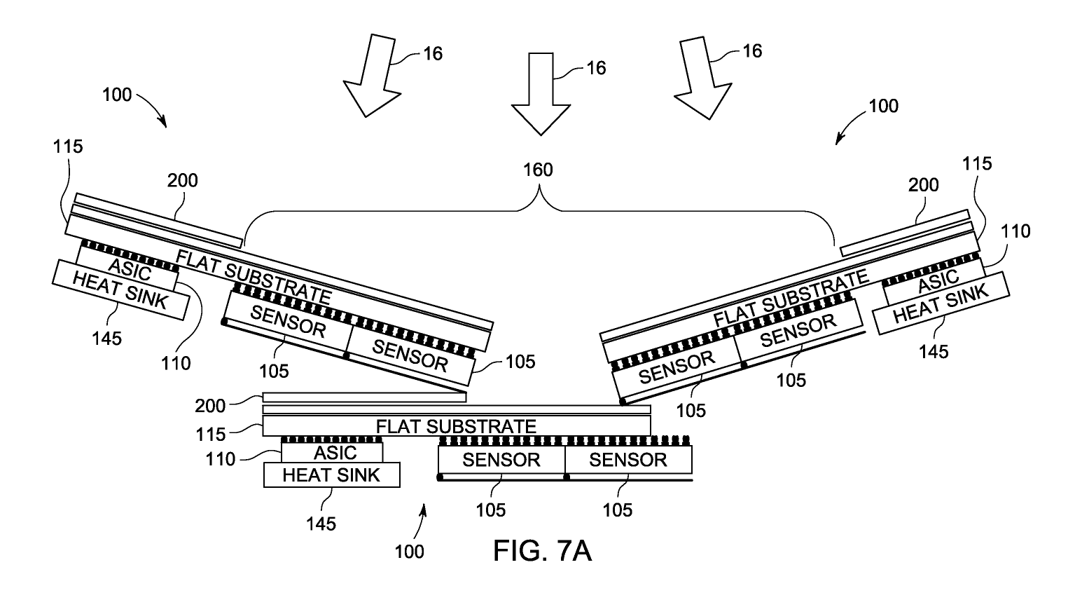

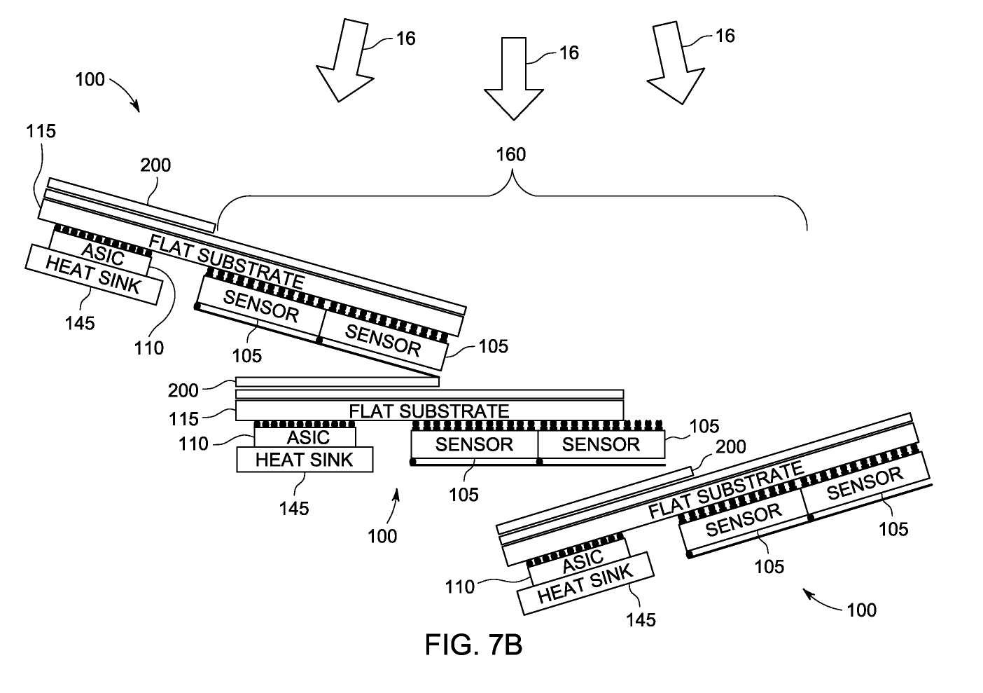

FIGS. 7A-7B show adjacent detector modules 100 arranged such that on each module 100, adjacent direct conversion sensors 105 abut and there is a fixed angular offset between the planes of adjacent detector modules such that the modules 100 reside in intersecting planes. Further, each of direct conversion sensors 105 are arranged such that substantially no part of each direct conversion sensors 105 are blocked from detecting an energy ray from the illumination source by adjacent detector modules 100.

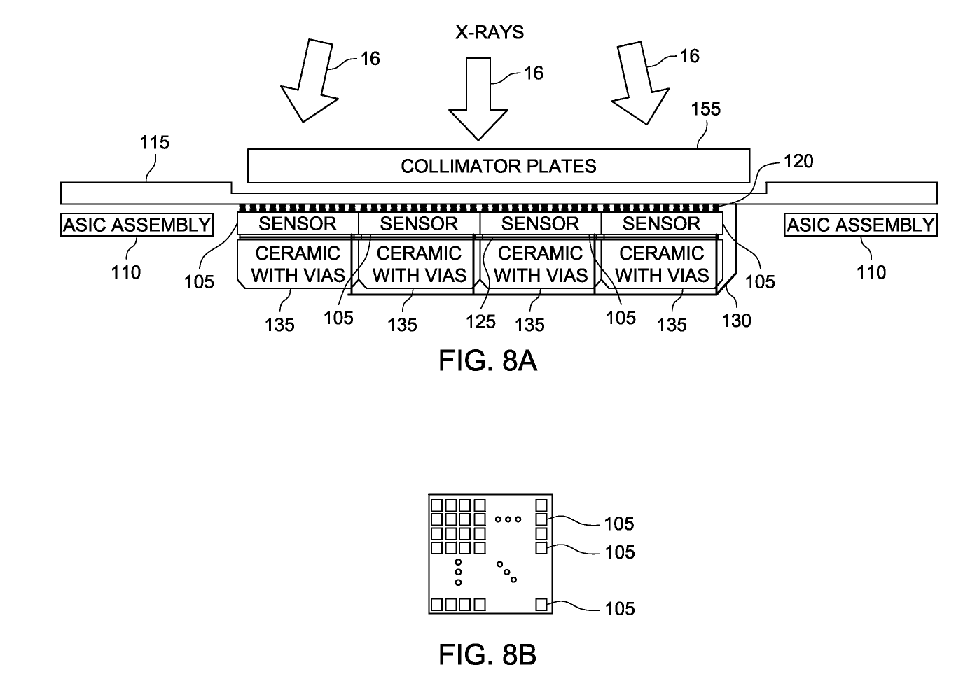

FIG. 8A-8B show a two-dimensional sensor-pixilation array structure with a plurality of direct conversion sensors 105 and collimator plate 155 disposed on the X-ray illumination side of substrate 115. As shown, a plurality of direct conversion sensors 105 can be connected to a single ASIC 110. This configuration advantageously provides that ASIC 110 need not be constrained by sensor size, e.g. sized to fit or hide behind one or more direct conversion sensors 105. This embodiment illustrates X-ray illumination of the substrate side of each sensor. If preferable, the module assembly, including the substrate, ASICs and sensors, may be inverted in place under the collimator plates to provide for X-ray illumination of the opposite side of all sensors.

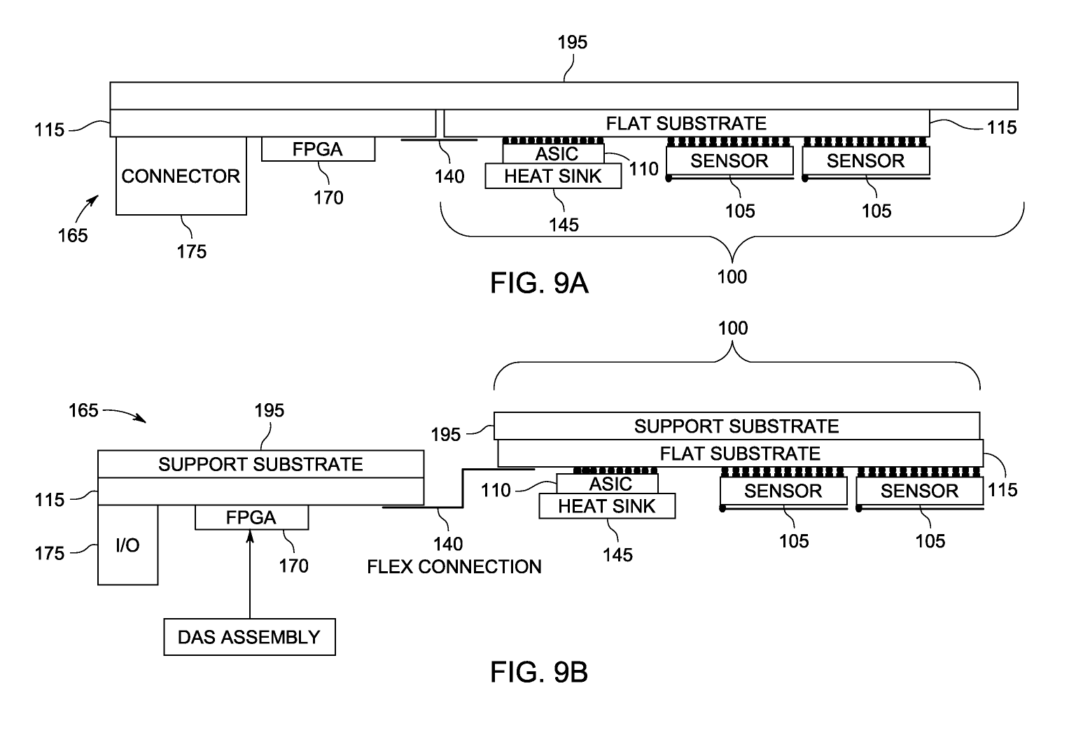

With reference to FIGS. 9A-9B, interposer layer 140 can be used to connect module 100 to a down-stream data acquisition system (DAS) 165. In an exemplary embodiment, DAS 165 consists of FPGA 170 for digital signal processing of ASIC 110 output and transfers results out through connector 175 to computer 36. DAS 165 can be incorporated on common substrate 115 as shown in FIG. 9A or on a separate substrate 115 as shown in FIG. 9B.

It will be apparent to those skilled in the art that, while the invention has been illustrated and described herein in accordance with the patent statutes, modification and changes may be made in the disclosed embodiments without departing from the true spirit and scope of the invention. It is, therefore, to be understood that the appended claims are intended to cover all such modifications and changes as fall within the true spirit of the invention.

1. A direct-conversion X-ray detector module comprising:
a substrate having a dielectric constant below about 3.5 and capable of lithographic conductor patterning with feature sizes of about 5 um or less;
at least one X-ray direct conversion sensor tile with an array of one or more electrodes electrically coupled to a first surface of the substrate;
at least one photon-counting application specific integrated circuit (ASIC) having a peaking time of 160 nanoseconds or less, the ASIC being electrically coupled to the substrate and disposed laterally along the substrate with respect to the direct conversion sensor tile; and
a plurality of conductive lines spaced along the substrate, wherein the plurality of lines are configured to electrically couple the at least one X-ray direct conversion sensor tile to the at least one ASIC.

2. The detector module of claim 1, wherein the ratio of spacing to width of the plurality of conductive lines is greater than 3:1.

3. The detector module of claim 1, wherein the width of each of the plurality of conductive lines is less than 5 microns.

4. The detector module of claim 1, wherein the spacing between each of the plurality of conductive lines is less than 25 microns.

5. The detector module of claim 1, wherein the ASIC is disposed within the substrate.

6. The detector module of claim 1, wherein at least one fusible link is disposed along at least one of the plurality of conductive lines, the at least one fusible link configured and adapted to provide electrostatic discharge protection.

7. The detector module of claim 1, wherein the at least one direct conversion tile and the at least one ASIC are disposed along a first surface of the substrate.

8. The detector module of claim 1, wherein the at least one direct conversion sensor tile is arranged to detect an energy ray that impinges through a second surface of the substrate.

9. The detector module of claim 1, wherein the at least one direct conversion sensor tile is arranged to detect an energy ray that impinges upon the sensor tile without passing through the substrate.

10. The detector module of claim 1, wherein the substrate is glass.

11. The detector module of claim 1, wherein the substrate is fused quartz.

12. The detector module of claim 1 further comprising:
a second substrate that includes a first and a second surface, each of the first and second surfaces containing electrical contact pads;
the contact pads disposed on the first surface are arranged so as to match the electrical contact pads of each ASIC;
the contact pads disposed on the second surface are arranged so as to match the termini of the conductive lines on the first substrate;
the second substrate provides electrical connection from the contact pads on the second surface to contact pads on the first surface by means such as through-vias;
the second substrate is placed between the first substrate and the ASICs;
the pads on the second surface of the second substrate are conductively attached to the termini of the conductive lines on the first substrate; and
the ASIC pads are conductively attached to the first surface of the second substrate.

13. The detector module of claim 12, wherein the second substrate provides additional electrical connections to enable distribution of power, control, and data signals between each ASIC and an external system.

14. The detector module of claim 12, wherein the second substrate is a flexible dielectric film, such as polyimide.

15. An imaging system, comprising:
an imaging source; and
a detector including a plurality of detector modules, each of the plurality of detector modules comprising:
a substrate having a dielectric constant below about 3.5 and capable of lithographic conductor patterning with feature sizes of about Sum or less;
at least one direct conversion sensor tile electrically coupled to a first surface of the substrate;
at least one photon-counting Application Specific Integrated Circuit (ASIC) having a peaking time of 160 nanoseconds or less, the ASIC being electrically coupled to the substrate and disposed laterally along the substrate with respect to the direct conversion sensor tile; and
a plurality of conductive lines spaced along the substrate, wherein the plurality of lines are configured to electrically couple each of the at least one direct conversion sensor tile to the at least one ASIC.

16. The imaging system of claim 15, wherein the plurality of detector modules are disposed laterally along a common plane.

17. The imaging system of claim 15, wherein the detector modules are disposed in an overlapping configuration.

18. The imaging system of claim 15, wherein adjacent sensor tiles on each of the plurality of detector modules abut and there is a fixed angular offset between the planes of adjacent detector modules.

19. The imaging system of claim 15, wherein each of the plurality of detector modules is arranged such that substantially no part of each of the at least one direct conversion sensor tiles are blocked from detecting an energy ray from the illumination source by adjacent detector modules.

20. The imaging system of claim 15, wherein each of the at least one direct conversion sensor tiles on each of the plurality of detector modules is arranged to detect an energy ray that impinges through a second surface of the substrate with substantially no part of any of each of the at least one direct conversion sensor tiles blocked by adjacent detector modules.
